(19) United States
(12) Patent Application Publication
(10) Pub. No.: US 2009/0106002 A1
(43) Pub. Date: Apr. 23, 2009

(54) PROCESS SIMULATION FRAMEWORK

(75) Inventors: Nungavaram Sundara Viswanathan, San Jose, CA (US); Matthias Frank, Dresden (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DFMSim, Inc.

(21) Appl. No.: 12/257,294

(22) Filed: Oct. 23, 2008

Related U.S. Application Data
(60) Provisional application No. 60/982,067, filed on Oct. 23, 2007.

(51) Int. Cl. G06G 7/48; G06F 15/18; G06F 3/00

(52) U.S. Cl. 703/6; 706/14; 715/700

(57) ABSTRACT

A process analysis and simulation framework is configured with several adaptable libraries that provide a user with the ability to select plug-in modules that are applicable to a particular process simulation. The user may add or remove modules to configure the framework with specific functionality and parameters according to the needs of a particular process simulation. The plug-in modules may execute individually or dependencies may be established between multiple plug-in modules. A simulation engine executes the process simulation to determine an optimized solution for the data. The data used in the execution of the process simulation may be manually input, provided by the plug-in modules, or retrieved from external sources. The output of the process simulation is displayed to the user and stored in a file or a database for future use. Thus, the stored output may be used in a subsequent process simulation to progressively refine an application.

### CROSS-REFERENCES TO RELATED APPLICATIONS

This application claims priority to U.S. Provisional Patent Application No. 60/982,067, filed on Oct. 23, 2007, which is incorporated herein for all purposes.

### TECHNICAL FIELD

The present invention relates to a process simulation framework that provides extendability to other manufacturing processes.

### BACKGROUND

Process simulations are used to predict the output of the modeling of a mathematical process representing a manufacturing or fabrication process. In a semiconductor process simulation, the fabrication of semiconductor devices is modeled. One goal of a semiconductor process simulation is an accurate prediction of the active dopant distribution, the stress distribution and the device geometry of the process in order to model the electrical characteristics of the device. The input for integrated circuit process simulation is a process flow and a layout of the integrated circuit.

Advanced process control (APC) and process simulation are gaining widespread acceptance as an important tool in high-volume semiconductor manufacturing. APC refers to a wide range of technical areas, from factory-level software systems to specific sensors implemented in particular tools. Currently, process engineers develop software modules for specific process simulation applications. This makes process simulations time consuming since each module is developed individually based on the particular application.

Therefore, what is needed is a modeling tool that is applicable to multiple simulations in order to provide flexibility and efficiency when developing different simulations and modeling semiconductor manufacturing and fabrication processes.

### SUMMARY

Embodiments of the present invention provide a process analysis and simulation framework that is configured with several adaptable libraries that provide a user with the ability to select plug-in modules that are applicable to a particular process simulation. The user may add or remove modules to configure the framework with specific functionality and parameters according to the needs of a particular process simulation. The plug-in modules may execute individually or dependencies may be established between multiple plug-in modules. A simulation engine executes the process simulation to determine an optimized solution for the data. The data used in the execution of the process simulation may be manually input, provided by the plug-in modules, or retrieved from external sources. The output of the process simulation is displayed to the user and exported to a file or a database for future use. Thus, the stored output may be used in a subsequent process simulation to progressively refine an application.

In some embodiments, the present invention is directed to a system for modeling process simulations. The system includes a simulation model repository, a user interface and a simulation engine. The simulation model repository is configured to store previously executed process simulations and plug-in modules that are used for modeling a process simulation. The user interface is configured to receive as input a selection of at least one primary plug-in module. The at least one selected primary plug-in module provides the process simulation with parameters and functionality. The simulation engine is configured to model the process simulation using the at least one selected primary plug-in module and to execute the modeled process simulation. The executed modeled process simulation may be stored in the simulation model repository.

In some embodiments, the present invention is directed to a method for modeling a process simulation. The method includes receiving as input a selection of at least one primary plug-in module. The selected primary plug-in module is retrieved from a simulation model repository. The simulation model repository stores previously created process simulations. A process simulation is modeled using the selected at least one primary plug-in module. The selected at least one primary plug-in module provides the process simulation with parameters and functionality. The modeled process simulation is then created by modeling and stored in the simulation model repository.

These and other advantages of the invention will be apparent to those of ordinary skill in the art by reference to the following detailed description and the accompanying drawings.

### BRIEF DESCRIPTION OF THE DRAWINGS

FIG. 1 is a functional block diagram of a front end and a back end of a process simulation framework illustrating how application software drives a server to create a database, and illustrating a process simulation application frame having functionality extended by plug-in modules.

FIG. 2 is a functional block diagram of an internal structure of process simulation framework in accordance with embodiments of the present invention.

FIG. 3 is a flow chart for illustrating a method for modeling process simulations in accordance with embodiments of the present invention.

FIG. 4 is a screen shot of a graphical user interface including optional plug-in modules.

FIG. 5 is a screen shot of a graphical user interface that provides selectable data representations.

FIG. 6 is a screen shot of a graphical interface that provides selectable data representations.

FIG. 7 is a screen shot of a graphical interface that provides selectable data representations.

FIG. 8 shows a field with dies, where a metrology tool recipe problem was recognized.

FIG. 9 is a screen shot of a graphical user interface showing an interactive analysis model.

FIG. 10 is a screen shot of a graphical user interface of intermediate analysis results and a parameter model.

FIG. 11 is a graphical user interface showing process simulation correction results of four semiconductor wafer layers.

FIG. 12 is a graphical user interface showing an example of a process simulation based on overlay tolerance management.

### DETAILED DESCRIPTION

Embodiments of the present invention provide process analysis and simulation framework that is configured with several adaptable libraries that provide a user with the ability to select plug-in modules that are applicable to a particular process simulation. The user may add or remove modules to configure the framework with specific functionality (e.g., algorithms) and parameters (e.g., values corresponding to process conditions) according to the needs of a particular process simulation. The plug-in modules may execute individually or dependencies may be established between multiple plug-in modules. A simulation engine executes the process simulation to determine an optimized solution for the data. The data used in the execution of the process simulation may be manually input, provided by the plug-in modules, or retrieved from external sources. The output of the process simulation is displayed to the user and stored in a file or database for future use. Thus, the stored output may be used in a subsequent process simulation to progressively refine an application.

Key features of the process simulation framework in accordance with embodiments of the invention are outlined below:
a. A user can interactively model, simulate or test process simulations and analysis algorithms based on available process data. Referring to a semiconductor processing example, when pressure is increased a metal deposition process proceeds more rapidly. Similarly, a decrease in pressure may increase metal resistance. A dependency parameter allows the process data (i.e., a measured value) to be used directly in the application.
b. Modeled algorithm outputs can be stored as independent modules or loaded into other applications. Once an application is developed, the application may be reused at a later time. For example, the output of a process simulation may be stored as a file or group of files for future use. Thus, the process simulation framework acts as a simulator/modeler at the front end and a database that stores modeled output for potential use in subsequent applications at the back end. The modeled output may also be submitted for dynamic and real time analysis. In this case, the framework uses the process output from a prior simulation model exercise to recursively refine the application.
c. The modeler may be run locally on a desktop computer using standard tools. The modeler may also utilize sever-based process analysis or simulation algorithms and fault detection and classification (FDC) algorithms commonly used in fabrication laboratories. Thus, a process engineer can simulate a process on a desktop computer without requiring large amounts of data from an external source or consuming excessive computational resources. The framework utilizes a small amount of data to provide a predictive model which becomes progressively refined through acquisition of actual process data.
d. The framework provides simple, fast and cost-efficient approach to process simulations without any major impact on manufacturing engineering system (MES) or information technology (IT) environments. The framework may operate independently (e.g., using manually input data). The framework may also interface with other existing applications available in the market (e.g., data may be accessed from an MES database).

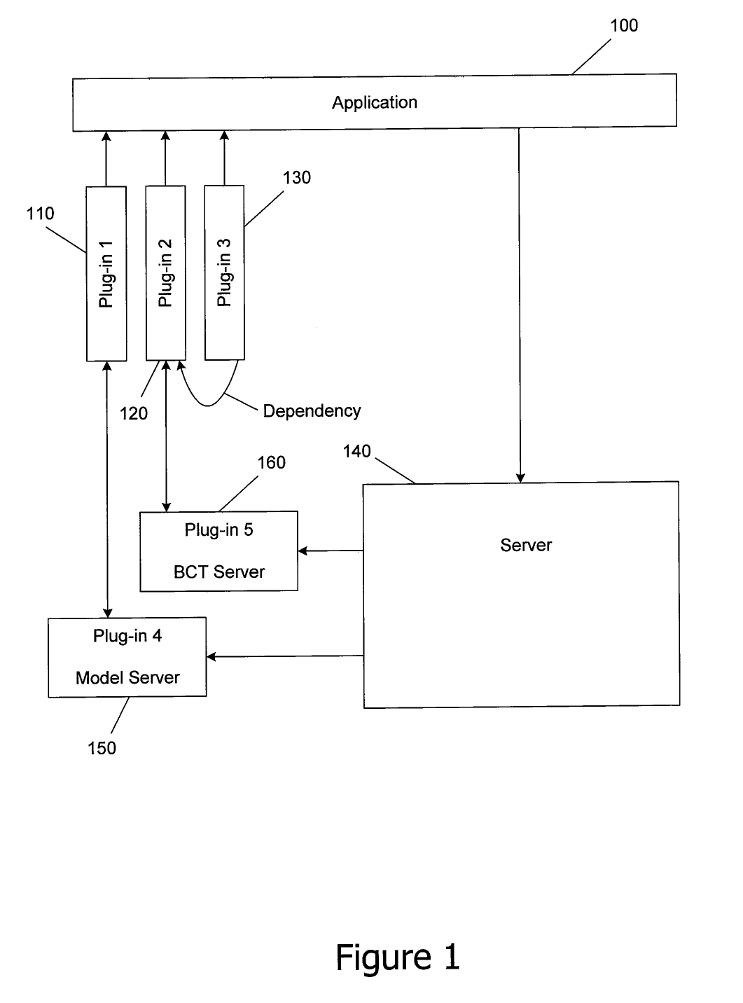

FIG. 1 is a functional block diagram of a front end and a back end of a process simulation framework illustrating how application software drives a server to create a database. FIG. 1 also illustrates a process simulation application having functionality extended by plug-in modules. As shown in FIG. 1, an application 100 is configured with certain general integrated functions. The functionality of the application 100 can be extended by adding any number of plug-in modules, such as plug-in modules 110, 120, 130.

Illustratively, to simulate a process of depositing metal on a semiconductor wafer, the plug-in modules can be defined as functional representations of input parameters such as pressure and volume of a deposition chamber, gas flow rate, temperature of the target, etc. Although the embodiments of the invention are generally described with reference to semiconductor and integrated circuit manufacturing, one having ordinary skill in the art would appreciate that the process simulation framework could be used to model any mathematical process. For example, in an automotive application simulation, the application 100 may include an application to start an engine. The plug-in module could be functionally defined as response vectors from key parameters such as fuel flow, timing offsets, ignition key response, and other parameters that would affect an engine starting process.

The plug-in modules may reuse functionality from other plug-in modules. When reusing functionality, a dependency exists between the modules (e.g. module 130 depends on module 120). Plug-in modules may also exist without any dependency on other plug-in modules. The plug-in functionality reuse technique reduces the effort of implementation for new functionality and provides additional flexibility through synergy effects.

As shown in FIG. 1, data may be provided from the application 100 to a server 140 that may act as a database. Example types of data may include a monitor state, server logs, and server functions. Additional plug-in modules may be added to established plug-in modules. For example plug-in module 150 may be added to plug-in module 110, and plug-in module 160 may be added to plug-in module 120. The additional plug-in modules provide secondary processors to the primary plug-in modules. This feature is useful for providing variations to a standard plug-in module.

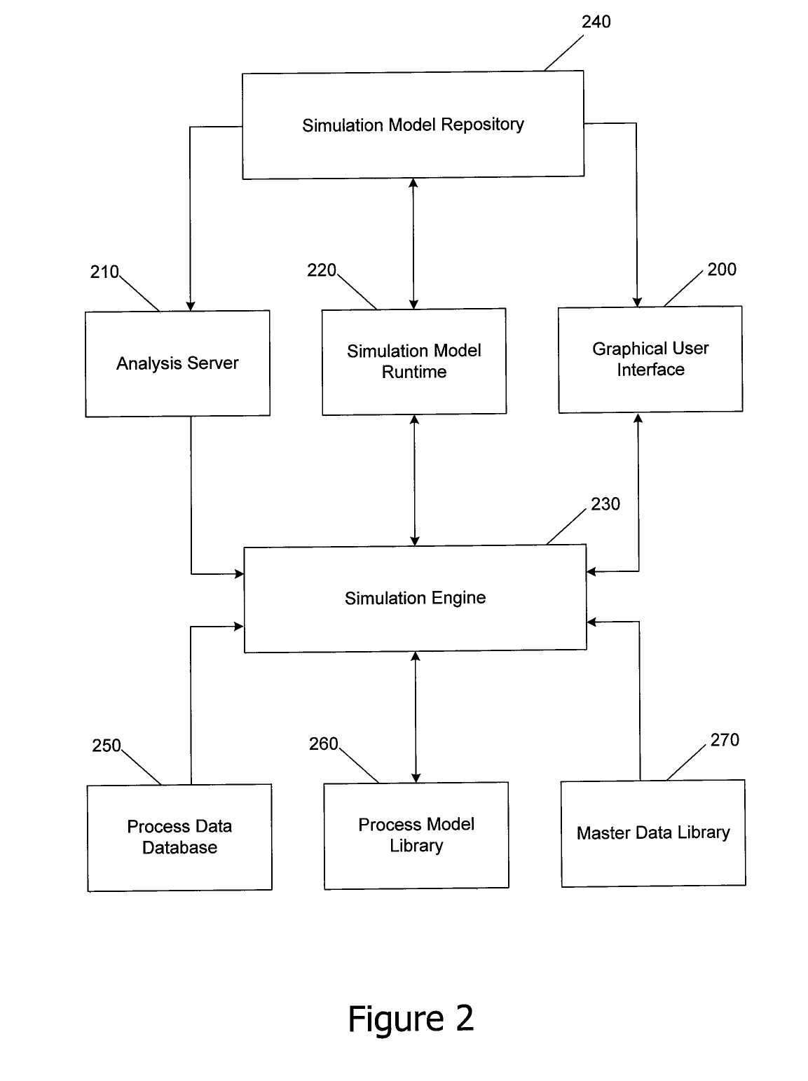

FIG. 2 is a functional block diagram of an internal structure of the inventive process simulation framework. The process simulation framework includes several modules, including front end modules, process engine modules and supporting modules. Front end modules are modules that are accessible by a user for inputting data, such as a graphical user interface 200. Example process engine modules include an analysis server 210, a simulation model runtime 220 and a simulation engine 230. Supporting modules provide look-up and storage functions such as libraries which may include a simulation model repository 240, a process data database 250, a process model library 260 and a master data library.

The graphical user interface 200 allows a user to create, simulate and edit simulation models. The analysis server 210 runs existing simulation models. The simulation model runtime 220 processes existing simulation models. The simulation engine 230 processes newly constructed process simulations based on the parameters and functionality configured by the user. The simulation model repository 240 includes the simulation models, functions and algorithms (i.e., active elements). The process data database 250 includes unchanged tool and metrology data from a process (e.g., a semiconductor process). The process model library 260 includes the current process model which is built from the model through several simulation cycles (e.g., descriptions, distributions, systematic failures, etc.). The master data library 270 includes the setup information for a process (e.g., technology, layer and device information; tool setup; function setup; control parameters for algorithms; etc.).

The simulation engine 230 receives applicable data from the graphical user interface 200, the analysis server 210, and/or the simulation model runtime 220 (via the simulation model repository 240). The simulation engine 230 simulates device fabrication and the development of process models under the control of the user or by calling applicable software modules. The simulation engine 230 determines an optimized solution for the data. The optimized solution is then output as a simulation model description and the process model may be stored in the process model library 260 for subsequent process simulations. The model description may generically define platform independent process and simulation models to facilitate transfer of the process and simulation models between fabrications.

The graphical user interface 200, the analysis server 210 and the simulation model runtime 230 may run a simulation/analysis model simultaneously or independently. Each of these applications may load and execute analysis modules, which describe a process simulation.

The graphical user interface 200 is a flexible front end application. This software supports a common interface for a process engineer to define, test and process complex analysis models and simulations. The process engineer can use the model to set and manipulate different parameters. In one embodiment, the graphical user interface 200 includes model driven software development (MDSD), where single analysis steps can be combined into more complex analyses and can be interactively simulated. The analysis steps, which are loaded from libraries and are offered in a menu, can be easily arranged as elements of the model using a drag and drop selection method. The model elements may then be connected to define data flow. Each analysis step may include set up and result views such that the user can interactively set up changes and view the corresponding results. The views in combination with the model logic form a new analysis application.

The analysis steps from independent loaded libraries may be mutually exclusive or combined as long as the parameter types are compatible. This allows any combination of proprietary process knowledge, which is transparent to the user. In other words, the user has full access to the provided functionality while preserving any proprietary aspects of the algorithms. Thus, a technician need not be knowledgeable about the specific operation of an algorithm or the process data. The architecture does not limit the number of libraries or the number of functional elements used inside an analysis model.

Depending on the existence of functional input elements, the graphical user interface 200 may be used to request data from existing databases or tools to be analyzed in real time on a desktop computer. The graphical user interface 200 can send the simulation models (e.g., algorithms) to the simulation model repository 240. A user of any process simulation application and the analysis server 210 can request the analysis models from the simulation model repository 240. The simulation model repository 240 may store many different analysis models. Alternatively, different repositories are provided that store a particular type of analysis model (e.g., one repository is used for etching and another repository is used for deposition).

The simulation model runtime 220 can be used to run any model from the simulation model repository 240. The simulation model runtime 220 executes when the simulation engine 230 begins processing the data of the analysis model. The user may not change the model during execution. For example, none of the algorithms may be modified. However, the user may interactively run the model and may make changes to the model setup. Thus, if the output provided from the simulation engine 230 is less than optimal in accordance with desired results, the user may modify the inputs or the sequence of the inputs, but the process data itself may not be dynamically changed.

The analysis server 210 runs as a stand-alone application and offers remote analysis services to other applications to handle generic process and simulation models. Incoming requests and data are combined with the assigned model from the simulation model repository 240. The setup of the loaded model may be updated by a current process context (e.g., a tool, recipe, etc.) or through a process related setup from the master data library 270 before the data is processed using the model. The analysis server 210 filters the data to optimize the input for the simulation model runtime 220.

The simulation model repository 240 stores all static models (i.e., algorithms) that may be subsequently loaded by the analysis server 210. In other words, the simulation model repository 240 provides central storage for global access to simulation and analysis models, while the process model library 260 provides global storage for process models (e.g. heuristics, distributions, etc.). When requesting a model, the application may override a model setup with dynamic information from different process data sources. Example process data sources include databases related to manufacturing engineering system (MES), engineering data analysis (EDA), statistical process control (SPC) or advanced process control (APC). The combination of the large number of existing functional elements stored in the simulation model repository 240 and the dynamic setup of the models allow the models to be used for any tool or process combination. Thus, a process engineer may efficiently design and test a solution using a wide range of available data.

The simulation model repository 240 allows the models to be accessed by an industry standard database to compliment existing systems with an open interface. For example, the simulation model repository 240 may be used to model and interactively test algorithms related to failure detection and classification (FDC), model predictive control (MPC), and APC. The simulation model repository 240 may also be used to simulate process changes related to APC or manufacturing and engineering technology (MET).

In one illustrative example, a full process simulation may include four different process steps for manufacturing a semiconductor, namely, a first lithography process, an etching process, a chemical-mechanical polishing process and a second lithography process. The analysis server 210 calls the simulation engine 230 for each simulated process step. The simulation engine 230 may load a corresponding process simulation model from the simulation model repository 240. The simulation engine 230 may configure the process simulation model by accessing data from the master data library 270, and a corresponding process model may be loaded from the process model library 260. The simulation engine then executes the configured process simulation model.

An additional analysis may then be performed on the executed process simulation model. The simulation engine 230 loads process data from the process data database 250. The executed process simulation model is compared with the process data. The process model is then updated in the process model library 260.

The result of each executed process step is stored in the process model library 260 and may be subsequently retrieved to execute a different process step. In one embodiment, result data may be accessed by third party applications using adapters. After all of the simulated process steps are executed, the simulation model runtime 220 returns the approved simulation model to the simulation model repository 240.

The simulation model repository 240 may include many different types of libraries. For example, a base library may include general semiconductor functionality. Parameters and functions provided by the base library may include, but are not limited to, data import, wafer layout import, data merge element, statistic calculator, coordinate converter, wafer layout projection, change notch orientation, transformation element, value operation element, filter data points based on location, filter based on layout, filter based on property, generate new values based on self defined parameter model, generate new values based on defined statistics, 3D wafer view, 3D field definition view, 2D wafer view, 2D field def view, table output, property view, generate data points based on die map or field map, redefine reference die or calculate yield probability, and other suitable parameters or functions.

Other example libraries include a defect library, a critical dimension library and an overlay library that are used to address major sources of yield loss. Parameters and functions provided by the defect library may include import KLA results file (KLARF) data, export KLARF data, filter by error class and visualize defects on wafer or field. Parameters and functions provided by the overlay library may include, but are not limited to, calculate systematic failure, extrapolate overlay on given points, calculate reverse yield, calculate yield prediction for a particular layer, export systematic failure, visualize overlay values on wafer or field, or simulate overlay failure propagation. Parameters and functions provided by the critical dimension library may include, but are not limited to, visualize critical dimension values on wafer or field, or import critical dimension data from critical dimension scanning electron microscopy (CD-SEM) tools.

Another type of library may include an APC/R2R (run-to-run) toolbox. The APC/R2R toolbox may include parameters and functionality to filter data by sigma values, provide a Grubbs filter, visualize R2R data or provide an exponentially weighted moving average (EWMA) controller.

In accordance with embodiments of the present invention, the process simulation framework is designed with variable levels of flexibility. Since the plug-in modules are customizable, they can receive data that is input manually or the data may be extracted from large databases. For engineering applications using smaller datasets, the process simulation framework provides a process engineer with the analysis capability for 1) setting process control scripts; 2) process simulation analysis with various models (e.g., Shewhart, EWMA variations, etc.); and 3) tool analysis (e.g., comparison of steppers, etch systems, etc.).

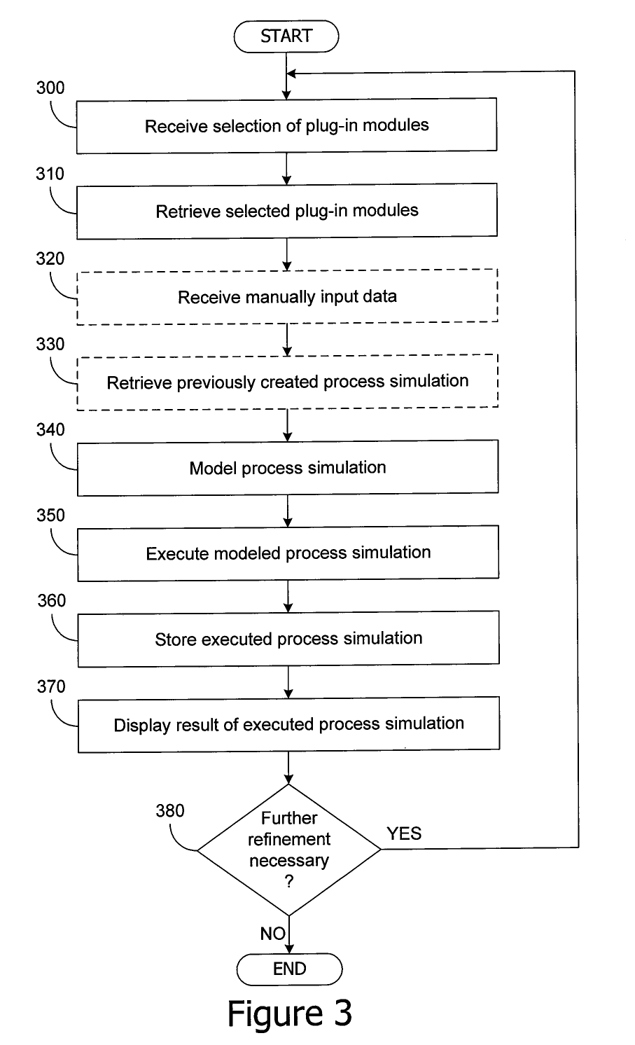

FIG. 3 is a flow chart for illustrating a method for modeling process simulations in accordance with embodiments of the present invention.

A selection of plug-in modules is received at a user interface (step 300). A plug-in module may be selected to provide applicable parameters and functionality to a particular process simulation. The plug-in modules may execute individually or dependencies may be established between multiple plug-in modules. Dependent plug-in modules allow the functionality of the plug-in modules to be combined and varied with minimal user effort. In some embodiments, a plug-in module is selected to remove the associated parameters and the functionality from the process simulation. The selected plug-in modules for providing parameters and functionality to the process simulation are then retrieved from a simulation model repository or a process model library (step 310).

Manually input data may be optionally received (step 320). The manually input data may be parameters and functionality entered by a user from the user interface. The user interface allows the user to create, simulate and edit simulation models. In some embodiments, the manually input data may identify an external data source, such as an existing application or a database, from which data is retrieved.

A previously created process simulation may be optionally retrieved from the simulation model repository (step 330). Thus, a user may provide the output of a previously executed process simulation to a current process simulation without reassembling all of the parameters and functionality associated with the previously created process simulation. This promotes efficiency in the use of computational resources.

The process simulation is modeled based on the selected plug-in modules, the optionally manually input data and the optionally retrieved previously created process simulation (step 340). The process simulation is modeled by parameters and functionality provided by the selected plug-in modules, the manually input data and/or the previously executed process simulation. Additional parameters and functionality may be provided by a master data library and/or a process model loaded from a process model library.

The modeled process simulation is executed to determine an optimized solution for the data (step 350). The executed process simulation model may be compared to corresponding process data in a process data database such that the process data may be updated to reflect the executed process simulation model. The executed process simulation model is then stored in the simulation model repository and the process model library for possible subsequent retrieval when modeling a different process simulation (step 360). The executed process simulation is exportable to any external supported data format (such as a file or a database) for future use. The stored output may be used as a plug-in module in a subsequent process simulation to progressively refine an application.

The result of the executed process simulation is then displayed to the user (step 370). The result may be displayed as a model description. A determination is then made whether the process simulation requires additional refinement (step 380). The user may desire to further refine the process simulation to take into account other considerations that may affect the process simulation (e.g., changing parameter values, additional algorithms, etc.). If further refinement is necessary, processing returns to step 300. Otherwise, processing terminates.

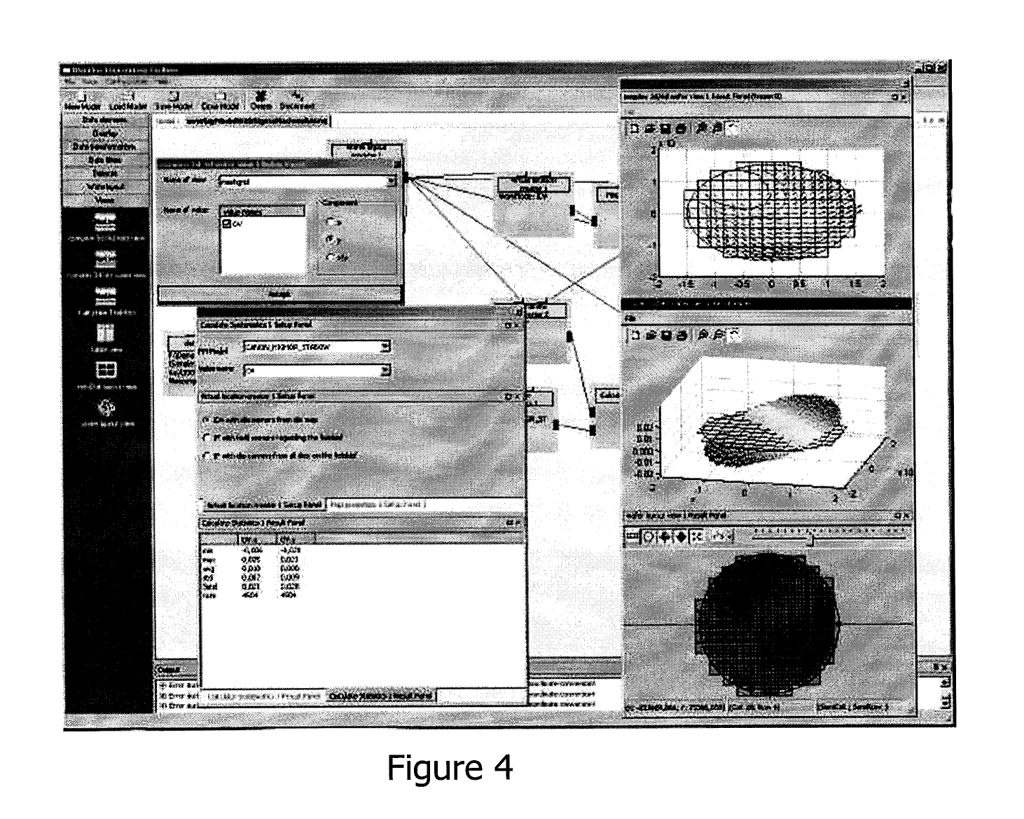

The process simulation framework has enhanced user interface capabilities, as described below with reference to FIGS. 4-12.

FIG. 4 is a screen shot of a graphical user interface including optional plug-in modules. The output of a semiconductor wafer model is shown in three images on the right side of the screen shot. The top image shows point locations as (x, y) coordinates. The middle image provides a wafer that may be tilted laterally to show wafer contours. The bottom image shows a grid mapping of the wafer using a rectangular coordinate system.

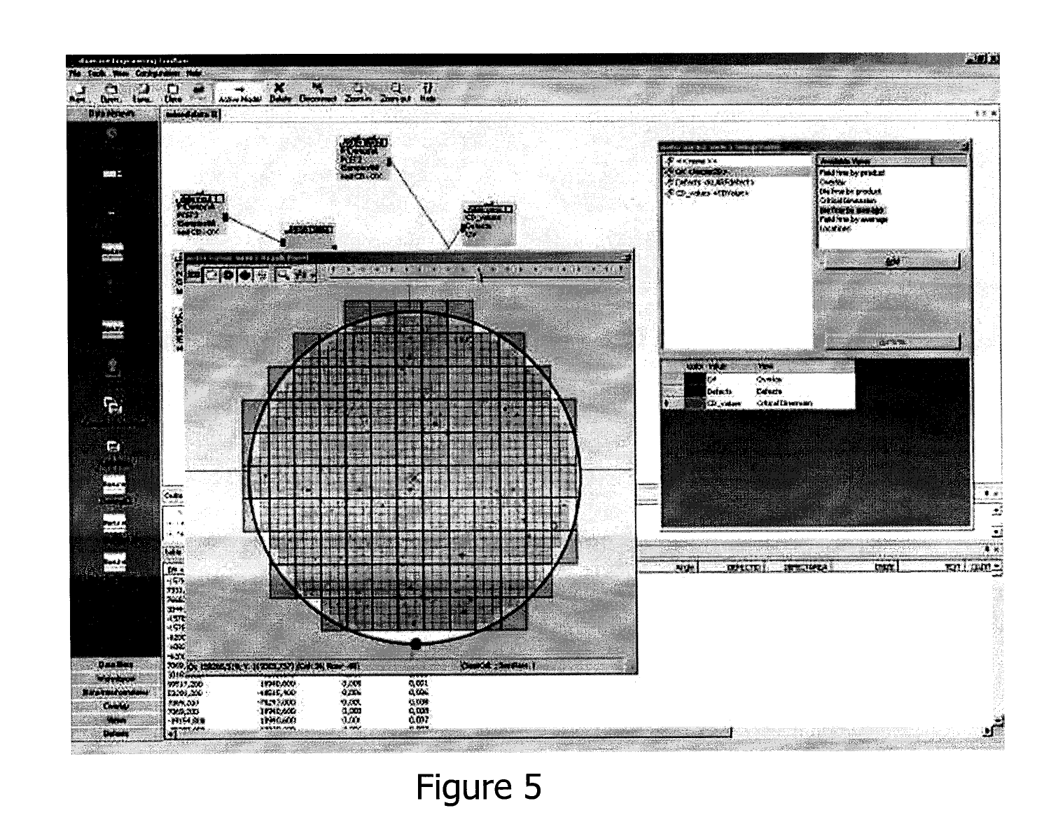

FIG. 5 is a screen shot of a graphical user interface that provides selectable data representations. As shown in the figure, the selected data visualization shows several layer defects across the wafer.

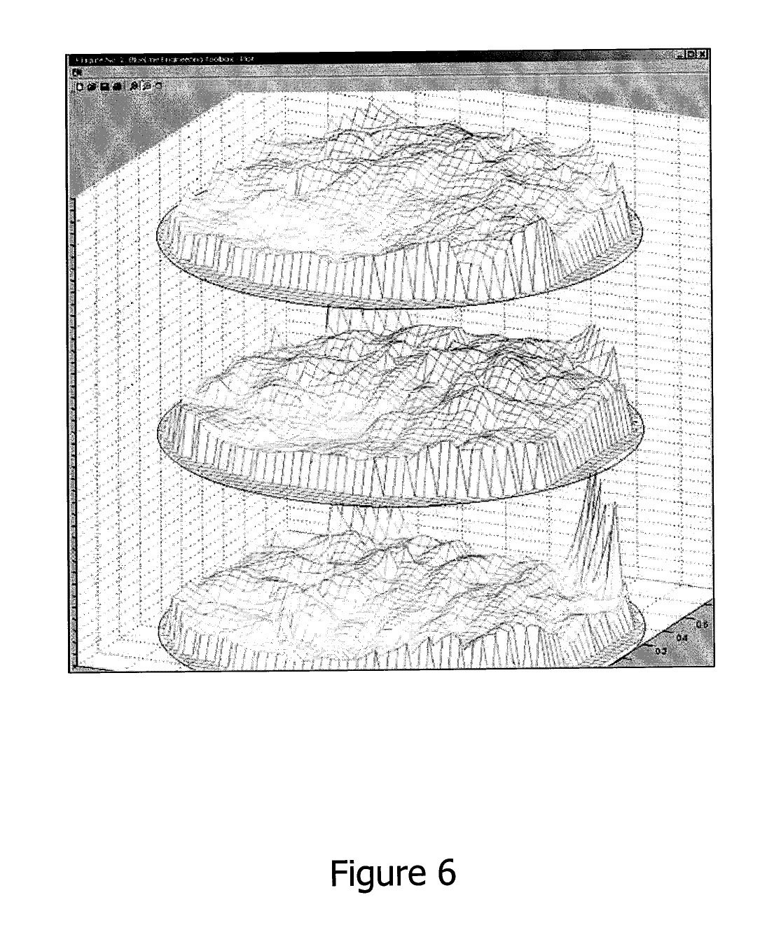

FIG. 6 is a screen shot of a graphical interface that provides selectable data representations. As shown in the figure, the selected data visualization shows stacked views of wafer signatures indicating variations in the wafer.

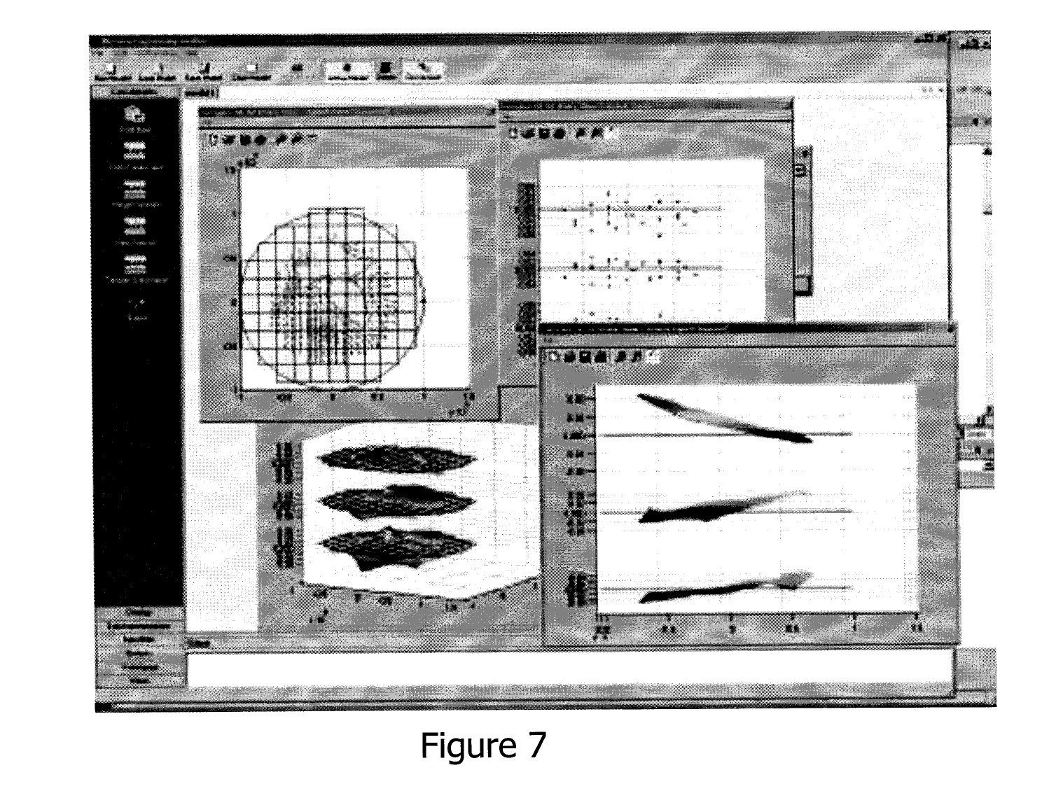

FIG. 7 is a screen shot of a graphical interface that provides selectable data representations. As shown in the figure, the selected data visualization is a three-dimensional visualization indicating, for example, overlay correction and stage bow analysis.

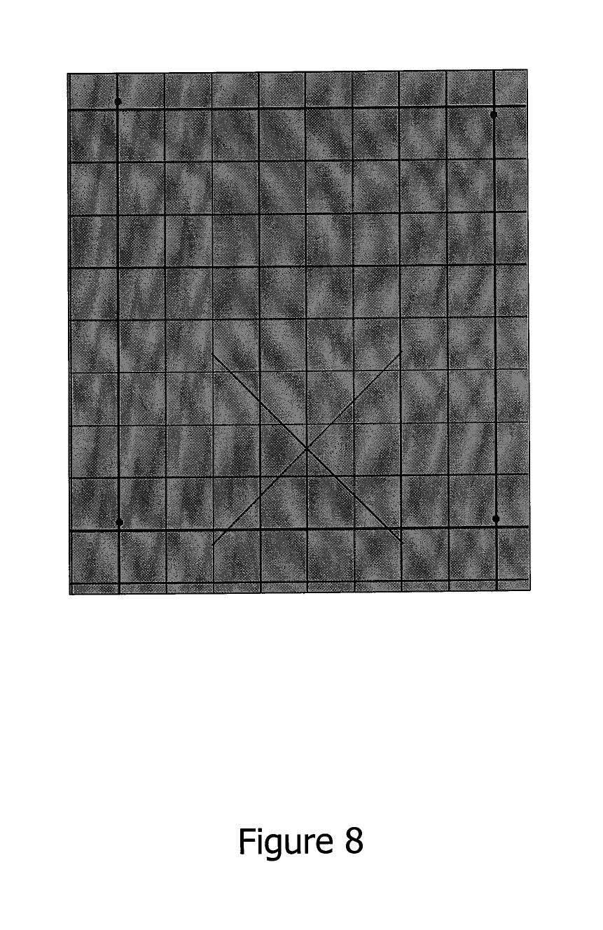

In one embodiment, the process simulation framework may be used as a diagnostic element. In this case, the plug-in data is available from manufacturing databases. The process engineer screens the process elements to identify errors (e.g., wrong scripts, coordinate errors, etc.). For example, tool recipes may be analyzed to check for wrong settings. FIG. 8 shows a field with dies, where a metrology tool recipe problem was recognized. In this case, an incorrect metrology recipe is found by the process simulation framework as indicated by the upper left dot that is located outside of the frame and which will result in overlay problems.

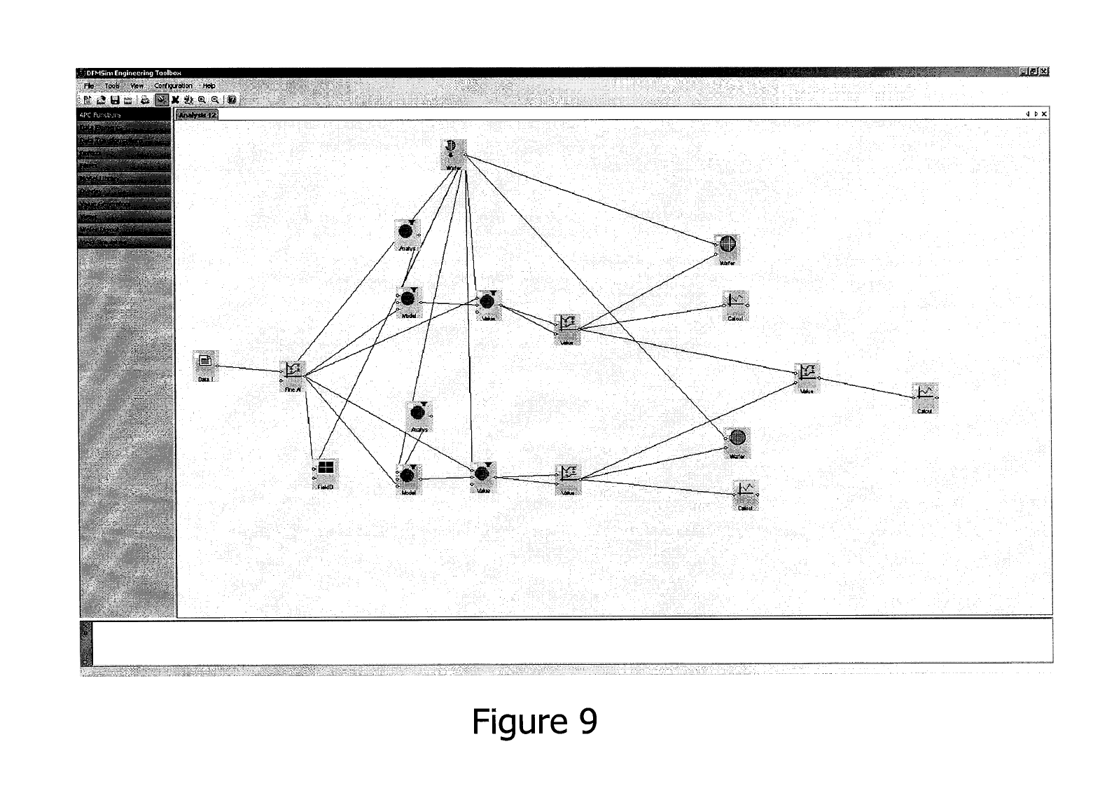

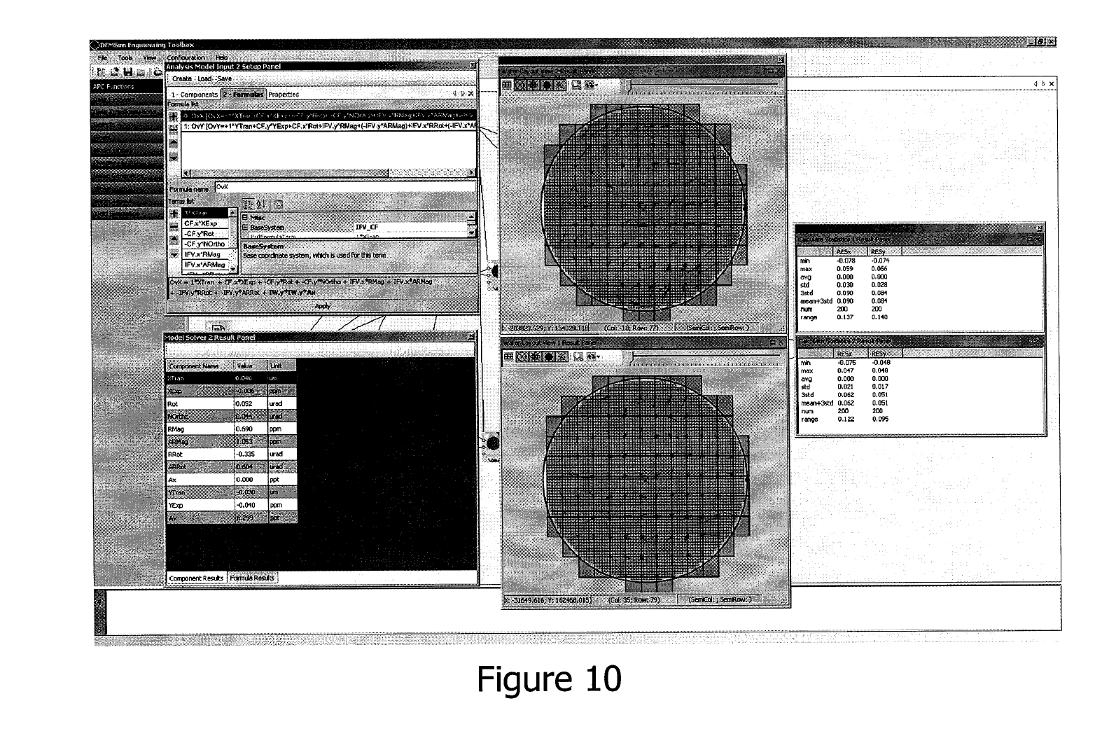

In case of process problems, the process simulation framework can analyze process data to find the root cause for the problem. Thus, the process engineer can be provided with the base contributor of the problem to address the issue efficiently without additional troubleshooting. FIG. 9 is a screen shot of a graphical user interface showing an interactive analysis model. In this example, the analysis model is used to find the root cause for an intra lot signature. Since raw overlay data may not be useful in addressing the problem, the process simulation framework is used to analyze residual data using an extended parameter model. FIG. 10 is a screen shot of a graphical user interface of intermediate results analysis and a parameter model.

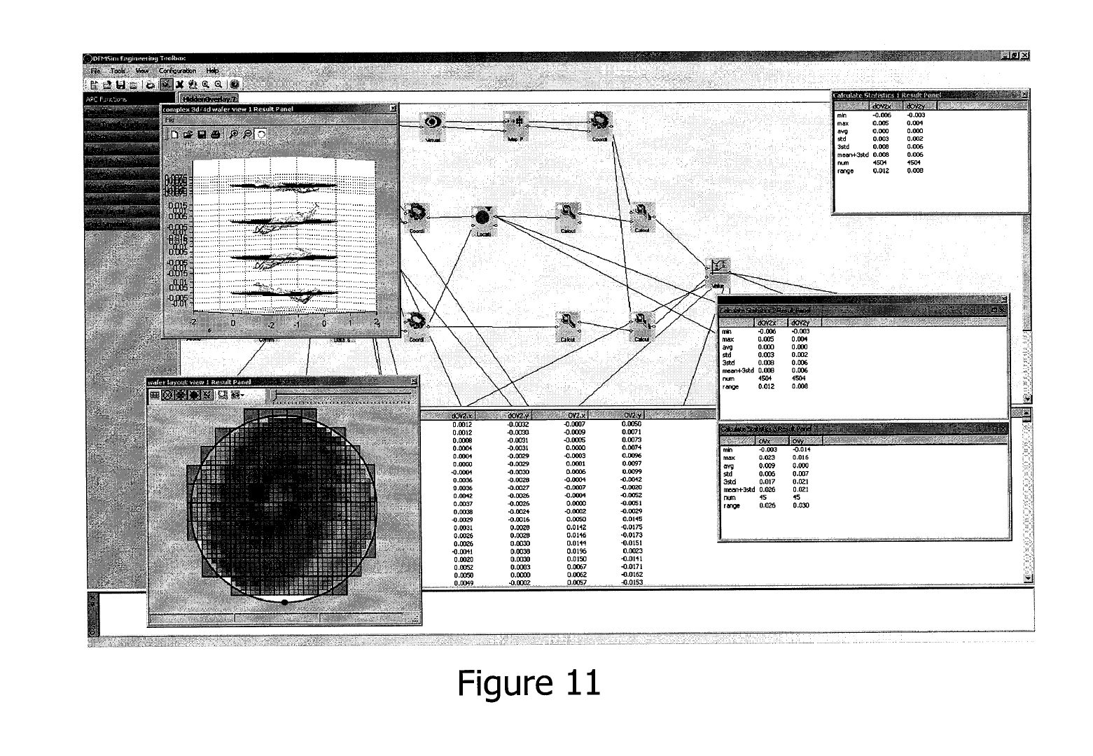

Stage bow characterization provides an example for illustrating the advantages provided by the process simulation framework. Conventionally, considerable resources are expended to estimate and eliminate stage bow error using several high level production tools for online analyses. The process simulation framework can perform the same analysis in a few minutes and corrections may be implemented at the engineering level. The process simulation framework provides answers to queries such as deciding whether to correct the stage bow, determining the best correction method, and finding short term solutions and long term solutions for the problem. FIG. 11 is a graphical user interface showing process simulation correction results of four semiconductor wafer layers.

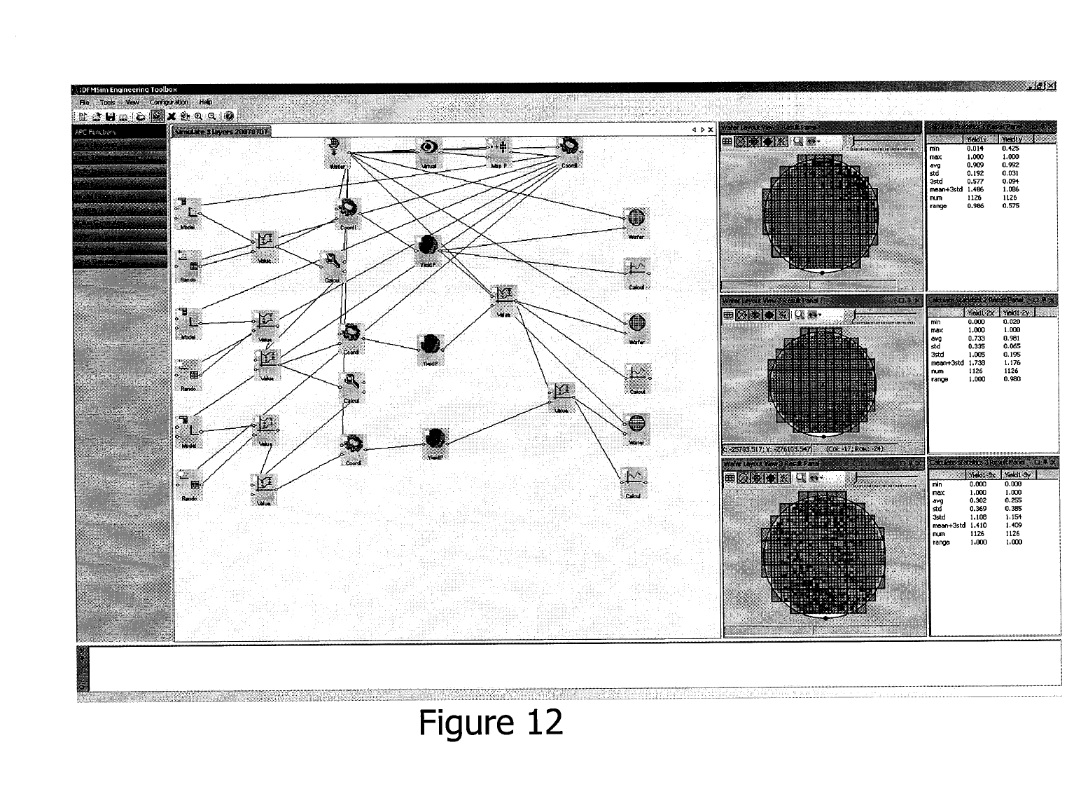

In a high volume manufacturing environment, the process simulation framework can be used to monitor quality. The process simulation framework may also be used to screen the process for robustness and allow the process engineer to apply corrections dynamically at the tool/process level. FIG. 12 is a graphical user interface showing an example of a process simulation based on overlay tolerance management. As shown in the figure, a failure is propagated through a stack of subsequent layers. In this use of the invention, an error in the manufacturing or fabrication process may be detected and corrected before expending significant resources.

As is apparent from the above description, embodiments of the present invention provide a process simulation framework that is configured with adaptable libraries that provide a user with the ability to select plug-in modules that are applicable to a particular process simulation. The user may add or remove modules to configure the framework with specific functionality and parameters according to the needs of a particular process simulation. The plug-in modules may execute individually or dependencies may be established between multiple plug-in modules. A simulator engine executes the process simulation to determine an optimized solution for the data. The data used in the execution of the process simulation may be manually input, provided by the plug-in modules, or retrieved from external sources. The output of the process simulation is displayed to the user and stored in a file or a database for future use. Thus, the stored output may be used in a subsequent process simulation to progressively refine an application.

The present invention has been described in terms of specific embodiments. As will be understood by those skilled in the art, the embodiments illustrated above may be modified, altered, and changed without departing from the scope of the present invention. The scope of the present invention is defined by the appended claims.

What is claimed is:

1. A system for modeling a process simulation, the system comprising:
a simulation model repository configured to store previously executed process simulations and plug-in modules that are used for modeling a process simulation;
a user interface configured to receive as input a selection of at least one primary plug-in module, wherein the at least one selected primary plug-in module provides the process simulation with parameters and functionality; and
a simulation engine configured to model the process simulation using the at least one selected primary plug-in module and to execute the modeled process simulation, wherein the executed process simulation is stored in the simulation model repository.

2. The system of claim 1, wherein the simulation engine is configured to model the process simulation using data retrieved from at least one of a process model library and a master data library.

3. The system of claim 2, wherein the executed process simulation is stored in the process model library.

4. The system of claim 1, wherein the simulation engine is configured to compare the executed process simulation to process data stored in a process data database and to update the process data database based on the comparison.

5. The system of claim 1, wherein the user interface is further configured to receive as input a selection of a secondary plug-in module, the secondary plug-in module being selected to depend on at least one of the at least one selected primary plug-in modules to provide the process simulation with additional parameters and functionality.

6. The system of claim 1, wherein the user interface is further configured to receive as input data that is manually entered by a user, the manually input data providing the modeled process simulation with additional parameters and functionality.

7. The system of claim 1, wherein the modeled process simulation is provided with additional parameters and functionality by retrieving a previously executed process simulation from the simulation model repository.

8. The system of claim 1, wherein the user interface is further configured to receive as input a selection of at least one secondary plug-in module, the at least one selected secondary plug-in module being selected to remove parameters and functionality from the modeled process simulation.

9. The system of claim 1, wherein the modeled process simulation corresponds to a semiconductor manufacturing process.

10. The system of claim 1, wherein the executed process simulation is retrieved from the simulation model repository to model a different process simulation.

11. A method for modeling a process simulation, the method comprising:
receiving as input a selection of at least one primary plug-in module;
retrieving the selected primary plug-in module from a simulation model repository, wherein the simulation model repository stores previously created process simulations;
modeling a process simulation using the selected at least one primary plug-in module, wherein the selected at least one primary plug-in module provides the process simulation with parameters and functionality;
executing the modeled process simulation; and
storing the executed process simulation in the simulation model repository.

12. The method of claim 11, wherein modeling the process simulation further comprises modeling the process simulation using data retrieved from at least one of a process model library and a master data library.

13. The method of claim 12, further comprising:
storing the executed process simulation in the process model library.

14. The method of claim 11, further comprising:
comparing the executed process simulation to process data stored in a process data database; and
updating the process data database based on the comparison.

15. The method of claim 11, further comprising:
receiving as input a selection of a secondary plug-in module, wherein the secondary plug-in module is selected to depend on at least one of the at least one selected primary plug-in modules to provide the process simulation with additional parameters and functionality.

16. The method of claim 11, further comprising:
receiving as input data that is manually entered by a user, wherein the manually input data provides the modeled process simulation with additional parameters and functionality.

17. The method of claim 11, further comprising:
receiving as input a selection of a previously executed process simulation; and
retrieving the selected previously executed process simulation from the simulation model repository, wherein the retrieved previously executed process simulation provides the modeled process simulation with additional parameters and functionality.

18. The method of claim 11, further comprising:
receiving as input a selection of at least one secondary plug-in module; and
removing parameters and functionality from the modeled process simulation based on the at least one selected secondary plug-in module.

19. The method of claim 11, further comprising:
retrieving the executed process simulation from the simulation model repository to model a different process simulation.

20. A server configured to perform the method of claim 11.

21. A computer program product having a computer readable medium storing a set of code modules which when executed by a processor of a computer system cause the processor to model a process simulation, the computer program product comprising:
code for receiving as input a selection of at least one primary plug-in module;
code for retrieving the selected primary plug-in module from a simulation model repository, wherein the simulation model repository stores previously executed process simulations;
code for modeling a process simulation using the selected at least one primary plug-in module, wherein the selected at least one primary plug-in module provides the process simulation with parameters and functionality;
code for executing the modeled process simulation; and
code for storing the executed modeled process simulation in the simulation model repository.

22. The computer program product of claim 21, further comprising:
code for receiving as input a selection of a previously executed process simulation; and
code for retrieving the selected previously executed process simulation from the simulation model repository, wherein the retrieved previously executed process simulation provides the modeled process simulation with additional parameters and functionality.
